(19) United States
(12) Patent Application Publication
(10) Pub. No.: US 2022/0070944 A1
(43) Pub. Date: Mar. 3, 2022

(54) METHOD AND APPARATUS FOR TWO-STEP RANDOM ACCESS PROCEDURE

(71) Applicant: Telefonaktiebolaget LM Ericsson (publ), Stockholm (SE)

(72) Inventor: Zhipeng Lin, Nanjing (CN)

(21) Appl. No.: 17/418,925

(22) PCT Filed: Jan. 3, 2020
(86) PCT No.: PCT/CN2020/070300

§ 371 Date: Jun. 28, 2021

(30) Foreign Application Priority Data
Jan. 7, 2019 (CN) PCT/CN2019/070625

(51) Int. Cl. H04W 74/08; H04W 74/00

(52) U.S. Cl. CPC H04W 74/0841; H04W 74/006; H04W 74/0866

(57) ABSTRACT

Various embodiments of the present disclosure provide methods and apparatuses for a two-step random access procedure. A method performed by a terminal device comprises determining a preamble for a two-step random access procedure, determining a radio network temporary identity, RNTI, for the two-step random access procedure according to RNTI information, generating a physical uplink shared channel, PUSCH, message based on the determined RNTI, and transmitting a request message comprising the preamble and the PUSCH message in the two-step random access procedure.

### FIELD OF THE INVENTION

The present disclosure generally relates to wireless communications, and more specifically, to methods and apparatuses for a two-step random access procedure.

### BACKGROUND

This section introduces aspects that may facilitate a better understanding of the disclosure. Accordingly, the statements of this section are to be read in this light and are not to be understood as admissions about what is in the prior art or what is not in the prior art.

In a new radio (NR) system, a four-step approach may be used for a random access procedure, as shown in FIG. 1. In this approach, a user equipment (UE) detects a synchronization signal (SS) which comprises NR-primary synchronization signal (NR-PSS), NR-secondary synchronization signal (NR-SSS) and NR-physical broadcast channel (PBCH) signal, and decodes broadcasted system information, e.g. remaining minimum system information (RMSI). Then the UE may transmit a physical random access channel (PRACH) preamble (message 1) in uplink (UL). In response to receiving the message 1, a base station (e.g. next generation node B (gNB)) replies with a random access response (RAR, message 2). The RAR message is octet aligned and comprises a timing advance command, a UL grant, and a temporary cell-radio network temporary identifier (TC-RNTI).

After receiving the RAR message, the UE may transmit a message 3 including UE identification and a transport block on a physical uplink shared channel (PUSCH). The gNB then replies with a contention resolution message (message 4). The timing advance command in the RAR message allows the message 3 to be received with a timing accuracy within a cyclic prefix (CP). Without this timing advance, a very large CP would be needed in order to be able to demodulate and detect the message 3, unless the system is applied in a cell with very small distance between the UE and the gNB. Since NR will also support larger cells with a need for providing a timing advance to the UE, the four-step approach is needed for the random access procedure.

The message 3 is scheduled by the UL grant in the RAR message. Retransmissions, if any, of the transport block in the message 3 are scheduled by a DCI format 0_0 with CRC scrambled by a TC-RNTI provided in the RAR message. The UE always transmits the message 3 without repetitions.

In 3GPP TS38.321, table 1 is provided to define a range of RNTI values as below.

TABLE 1

| Value (hexa-decimal) | RNTI |
|---|---|
| 0000 | N/A |
| 0001-FFEF | Random Access (RA)-RNTI, Temporary C-RNTI, |
| | C-RNTI, MCS-C-RNTI, CS-RNTI, TPC-PUCCH- |
| | RNTI, TPC-PUSCH-RNTI, TPC-SRS-RNTI, |
| | INT-RNTI, SFI-RNTI, and SP-CSI-RNTI |
| FFF0-FFFD | Reserved |
| FFFE | P-RNTI |
| FFFF | SI-RNTI |

A two-step random access procedure has been approved as a work item for NR release 16. As illustrated in FIG. 2, an initial access is completed in only two steps. At the first step, the UE sends a message, which may be called message A, including a random access preamble together with higher layer data such as radio resource control (RRC) connection request possibly with some small payload on PUSCH. At the second step, the gNB sends to the UE a response message, which may be called message B, including e.g. UE identifier assignment, timing advance information, and contention resolution message, etc.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

The present disclosure proposes an improved solution for a two-step random access procedure.

According to a first aspect of the present disclosure, there is provided a method performed by a terminal device. The method comprises determining a preamble for a two-step random access procedure, determining a radio network temporary identity, RNTI, for the two-step random access procedure according to RNTI information, and generating a physical uplink shared channel, PUSCH, message based on the determined RNTI. The method further comprises transmitting a request message comprising the preamble and the PUSCH message in the two-step random access procedure.

In accordance with an exemplary embodiment, the preamble may be determined from a set of preambles, and the RNTI information may indicate an association between the set of preambles and a set of RNTIs.

In accordance with an exemplary embodiment, the association may be any of one-to-one mapping between a preamble in the set of preambles and an RNTI in the set of RNTIs, one-to-more mapping between a preamble in the set of preambles and two or more RNTIs in the set of RNTIs, or more-to-one mapping between two or more preambles in the set of preambles and an RNTI in the set of RNTIs.

In accordance with an exemplary embodiment, the RNTI may be determined based on the determined preamble.

In accordance with an exemplary embodiment, the RNTI information may indicate an association between a set of physical random access channel, PRACH, occasions and a set of RNTIs.

In accordance with an exemplary embodiment, the association may be any of one-to-one mapping between a PRACH occasion in the set of PRACH occasions and an RNTI in the set of RNTIs, one-to-more mapping between a PRACH occasion in the set of PRACH occasions and two or more RNTIs in the set of RNTIs, or more-to-one mapping between two or more PRACH occasions in the set of PRACH occasions and an RNTI in the set of RNTIs.

In accordance with an exemplary embodiment, the RNTI may be determined based on the PRACH occasion used for the determined preamble.

In accordance with an exemplary embodiment, the RNTI information may indicate at least one RNTI.

In accordance with an exemplary embodiment, the RNTI information may indicate a plurality of RNTIs. Further, the RNTI may be determined randomly from the plurality of RNTIs.

In accordance with an exemplary embodiment, a preamble may be associated with a PUSCH time-frequency resource.

In accordance with an exemplary embodiment, the RNTI information may be predefined or signaled in a signaling message.

In accordance with an exemplary embodiment, the preamble may be determined according to preamble information, and the preamble information may be predefined or signaled in a signaling message.

In accordance with an exemplary embodiment, the signaling message may be a radio resource control, RRC, message.

In accordance with an exemplary embodiment, the method may further comprise receiving, in response to transmitting the request message, a response message comprising a selected RNTI. Further, the selected RNTI may be used in a subsequent two-step random access procedure.

In accordance with an exemplary embodiment, the response message may be received on a physical downlink shared channel, PDSCH, or a physical downlink control channel, PDCCH.

According to a second aspect of the present disclosure, there is provided a method performed by a network node. The method comprises receiving a request message including a preamble and a physical uplink shared channel, PUSCH, message in a two-step random access procedure, the PUSCH message being based on a radio network temporary identity, RNTI, determined according to RNTI information.

In accordance with an exemplary embodiment, receiving the request message may comprise detecting the preamble in the request message, determining the RNTI based on the detected preamble according to the RNTI information, and decoding the PUSCH message based on the determined RNTI.

In accordance with an exemplary embodiment, receiving the request message may comprise detecting the preamble in the request message, determining the RNTI based on a PRACH occasion used for the detected preamble according to the RNTI information, and decoding the PUSCH message based on the determined RNTI.

In accordance with an exemplary embodiment, receiving the request message may comprise detecting the preamble in the request message, and blindly decoding the PUSCH message based on the plurality of RNTIs.

In accordance with an exemplary embodiment, the method may further comprise generating, in response to successfully detecting the preamble in the request message and failing to decode the PUSCH message, an RA-RNTI based on the detected preamble, and transmitting a response message based on the RA-RNTI, the response message comprising a selected RNTI to be used in a subsequent two-step random access procedure.

In accordance with an exemplary embodiment, the response message may be transmitted on a physical downlink shared channel, PDSCH, or a physical downlink control channel, PDCCH.

According to a third aspect of the present disclosure, there is provided a terminal device. The terminal device may comprise one or more processors and one or more memories comprising computer program codes. The one or more memories and the computer program codes may be configured to, with the one or more processors, cause the terminal device at least to perform any step of the method according to the first aspect of the present disclosure.

According to a fourth aspect of the present disclosure, there is provided a computer-readable medium having computer program codes embodied thereon which, when executed on a computer, cause the computer to perform any step of the method according to the first aspect of the present disclosure.

According to a fifth aspect of the present disclosure, there is provided a network node. The network node may comprise one or more processors and one or more memories comprising computer program codes. The one or more memories and the computer program codes may be configured to, with the one or more processors, cause the network node at least to perform any step of the method according to the second aspect of the present disclosure.

According to a sixth aspect of the present disclosure, there is provided a computer-readable medium having computer program codes embodied thereon which, when executed on a computer, cause the computer to perform any step of the method according to the second aspect of the present disclosure.

### BRIEF DESCRIPTION OF THE DRAWINGS

The disclosure itself, the preferable mode of use and further objectives are best understood by reference to the following detailed description of the embodiments when read in conjunction with the accompanying drawings, in which:

FIG. 1 is a diagram illustrating a four-step random access procedure in NR;

FIG. 2 is a diagram illustrating a two-step random access procedure in NR;

FIG. 3 is a flowchart illustrating a method performed by a terminal device according to some embodiments of the present disclosure;

FIG. 4 is a flowchart illustrating a method performed by a network node according to some embodiment of the present disclosure;

FIG. 5 is a block diagram illustrating an apparatus according to some embodiments of the present disclosure;

FIG. 6 is a block diagram illustrating an apparatus according to some embodiments of the present disclosure;

FIG. 7 is a block diagram illustrating an apparatus according to some embodiments of the present disclosure;

FIG. 8 is a block diagram illustrating a telecommunication network connected via an intermediate network to a host computer in accordance with some embodiments of the present disclosure;

FIG. 9 is a block diagram illustrating a host computer communicating via a base station with a UE over a partially wireless connection in accordance with some embodiments of the present disclosure;

FIG. 10 is a flowchart illustrating a method implemented in a communication system, in accordance with an embodiment of the present disclosure;

FIG. 11 is a flowchart illustrating a method implemented in a communication system, in accordance with an embodiment of the present disclosure;

FIG. 12 is a flowchart illustrating a method implemented in a communication system, in accordance with an embodiment of the present disclosure; and

FIG. 13 is a flowchart illustrating a method implemented in a communication system, in accordance with an embodiment of the present disclosure.

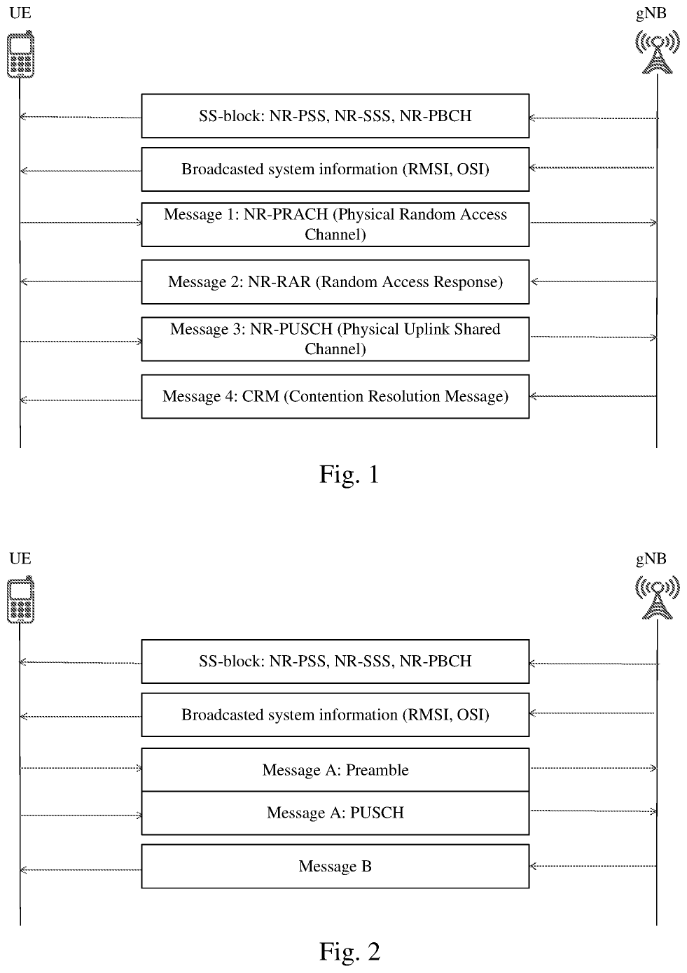

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “communication network” refers to a network following any suitable communication standards, such as new radio (NR), long term evolution (LTE), LTE-Advanced, wideband code division multiple access (WCDMA), high-speed packet access (HSPA), and so on. Furthermore, the communications between a terminal device and a network node in the communication network may be performed according to any suitable generation communication protocols, including, but not limited to, the first generation (1G), the second generation (2G), 2.5G, 2.75G, the third generation (3G), 4G, 4.5G, 5G communication protocols, and/or any other protocols either currently known or to be developed in the future.

The term “network node” refers to a network device in a communication network via which a terminal device accesses to the network and receives services therefrom. The network node or network device may refer to a base station (BS), an access point (AP), a multi-cell/multicast coordination entity (MCE), a controller or any other suitable device in a wireless communication network. The BS may be, for example, a node B (NodeB or NB), an evolved NodeB (eNodeB or eNB), a next generation NodeB (gNodeB or gNB), an IAB node, a remote radio unit (RRU), a radio header (RH), a remote radio head (RRH), a relay, a low power node such as a femto, a pico, and so forth.

Yet further examples of the network node comprise multi-standard radio (MSR) radio equipment such as MSR BSs, network controllers such as radio network controllers (RNCs) or base station controllers (BSCs), base transceiver stations (BTSs), transmission points, transmission nodes, positioning nodes and/or the like. More generally, however, the network node may represent any suitable device (or group of devices) capable, configured, arranged, and/or operable to enable and/or provide a terminal device access to a wireless communication network or to provide some service to a terminal device that has accessed to the wireless communication network.

The term “terminal device” refers to any end device that can access a communication network and receive services therefrom. By way of example and not limitation, the terminal device may refer to a user equipment (UE), or other suitable devices. The UE may be, for example, a subscriber station, a portable subscriber station, a mobile station (MS) or an access terminal (AT). The terminal device may include, but not limited to, portable computers, image capture terminal devices such as digital cameras, gaming terminal devices, music storage and playback appliances, a mobile phone, a cellular phone, a smart phone, a tablet, a wearable device, a personal digital assistant (PDA), a vehicle, and the like.

As yet another specific example, in an Internet of things (IoT) scenario, a terminal device may also be called an IoT device and represent a machine or other device that performs monitoring, sensing and/or measurements etc., and transmits the results of such monitoring, sensing and/or measurements etc. to another terminal device and/or a network equipment. The terminal device may in this case be a machine-to-machine (M2M) device, which may in a 3rd generation partnership project (3GPP) context be referred to as a machine-type communication (MTC) device.

As one particular example, the terminal device may be a UE implementing the 3GPP narrow band Internet of things (NB-IoT) standard. Particular examples of such machines or devices are sensors, metering devices such as power meters, industrial machinery, or home or personal appliances, e.g. refrigerators, televisions, personal wearables such as watches etc. In other scenarios, a terminal device may represent a vehicle or other equipment, for example, a medical instrument that is capable of monitoring, sensing and/or reporting etc. on its operational status or other functions associated with its operation.

As used herein, the terms “first”, “second” and so forth refer to different elements. The singular forms “a” and “an” are intended to include the plural forms as well, unless the context clearly indicates otherwise. The terms “comprises”, “comprising”, “has”, “having”, “includes” and/or “including” as used herein, specify the presence of stated features, elements, and/or components and the like, but do not preclude the presence or addition of one or more other features, elements, components and/or combinations thereof. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

As described above, in the two-step random access procedure as shown in FIG. 2, the preamble and the PUSCH message will be transmitted by the UE in one message called message A. But for the PUSCH message in message A, as no RAR message is received from the gNB, there is no TC-RNTI available for PUSCH handling. Therefore, it would be desirable to provide a solution for determining the RNTI for the PUSCH in message A in the two-step random access procedure.

In accordance with some exemplary embodiments, the present disclosure provides improved solutions for the two-step random access procedure. These solutions may be applied to a wireless communication system including a terminal device and a base station. In the two-step random access procedure, the terminal device may determine an RNTI to be used for a PUSCH in a request message (e.g. message A) according to RNTI information, and then the terminal device may transmit the request message based on the determined RNTI. With the improved solutions, the RNTI used for the PUSCH in message A can be determined.

It is noted that some embodiments of the present disclosure are mainly described in relation to 5G specifications being used as non-limiting examples for certain exemplary network configurations and system deployments. As such, the description of exemplary embodiments given herein specifically refers to terminology which is directly related thereto. Such terminology is only used in the context of the presented non-limiting examples and embodiments, and does not limit the present disclosure naturally in any way. Rather, any other system configuration or radio technologies may equally be utilized as long as exemplary embodiments described herein are applicable.

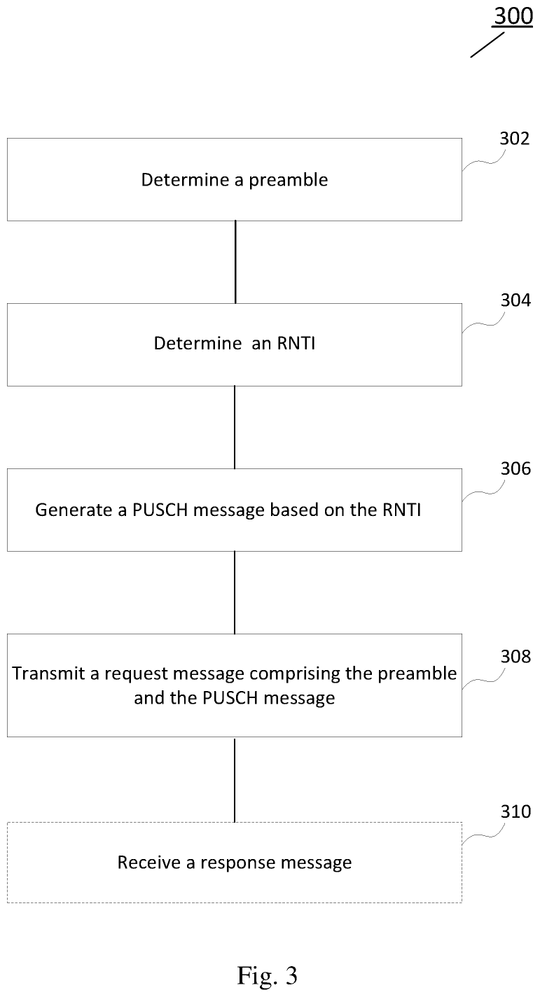

FIG. 3 is a flowchart illustrating a method 300 according to some embodiments of the present disclosure. The method 300 illustrated in FIG. 3 may be performed by an apparatus implemented in a terminal device or communicatively coupled to a terminal device. In accordance with an exemplary embodiment, the terminal device may be a UE.

According to the exemplary method 300 illustrated in FIG. 3, the terminal device determines a preamble for a two-step random access procedure, as shown in block 302. In some embodiments, the preamble may be determined according to preamble information. In an embodiment, the preamble information may indicate a set of preambles. The set of preambles may be specific for the two-step random access procedure. Alternatively, the set of preambles may be the same as those for the four-step random access procedure. In some embodiments, the preamble information may further indicate a set of time-frequency PRACH occasions (hereinafter referred to as “PRACH occasion”). The terminal device may select one of the set of PRACH occasions to transmit the preamble on a PRACH.

In some embodiments, the preamble information may be signaled in a signaling message from a network node such as a base station (e.g. a gNB). The signaling message may be a radio resource control (RRC) message. Alternatively, in some embodiments, the preamble information may be predefined in the terminal device.

In some embodiments, a preamble of the set of preambles in the preamble information may be associated with a PUSCH time-frequency resource. Therefore, the PUSCH time-frequency resource can be determined based on the preamble. For example, the terminal device may have a mapping table indicating the association between the set of preambles and the PUSCH time-frequency resources. After determining the preamble, the terminal device may determine the PUSCH time-frequency resource to be used for a PUSCH message based on the determined preamble. On the other hand, once the PUSCH time-frequency resource for a two-step random access procedure is determined, the terminal device may also determine the preamble according to the determined PUSCH time-frequency resource.

In block 304, the terminal device determines an RNTI for the two-step random access procedure according to RNTI information. In some embodiments, the RNTI information may indicates an association between the set of preambles in the preamble information and a set of RNTIs. Therefore, the RNTI can be determined based on the preamble.

In an embodiment, the association may be a one-to-one mapping between a preamble in the set of preambles and an RNTI in the set of RNTIs. For example, assuming the preamble information indicates a set of 64 preambles, a unique preamble ID is allocated for each preamble in a range from 0 to 63. Each preamble is mapped to one RNTI used for the PUSCH, as shown in table 2 below.

TABLE 2

| Preamble ID | RNTI for PUSCH |
|---|---|
| 0 | FF00 |
| 1 | FF01 |
| 2 | FF02 |
| . . . | . . . |
| 61 | FF3D |
| 62 | FF3E |
| 63 | FF3F |

In an embodiment, the association may be a one-to-more mapping between a preamble in the set of preambles and two or more RNTIs in the set of RNTIs. In this case, each preamble is mapped to two or more RNTIs. Based on the determined preamble, the terminal device may randomly select one RNTI from the corresponding two or more RNTIs. Alternatively, in an embodiment, the association may be a more-to-one mapping between two or more preambles in the set of preambles and an RNTI in the set of RNTIs. In this case, two or more preambles are mapped to one RNTI.

As described above, there may also be the association between the set of preambles and the PUSCH time-frequency resources. Therefore, in some embodiments, the RNTI may be determined based on the PUSCH time-frequency resource. For example, when the PUSCH time-frequency resource is determined for a two-step random access procedure, the terminal device may determine the preamble according to the association between the set of preambles and the PUSCH time-frequency resources, and then determine the RNTI according to the association between the set of preambles and the set of RNTIs. More directly, there may be an association between the PUSCH time-frequency resources and RNTIs. Thus, when the PUSCH time-frequency resource is determined, the corresponding RNTI can be determined.

Alternatively, in some embodiments, the RNTI information may indicate an association between a set of PRACH occasions and a set of RNTIs. Therefore, the RNTI may be determined based on the PRACH occasion. After determining the preamble, the terminal device may determine the RNTI based on the PRACH occasion used for the determined preamble. In an embodiment, the set of PRACH occasions may also be indicated in the preamble information.

In an embodiment, the association may be a one-to-one mapping between a PRACH occasion in the set of PRACH occasions and an RNTI in the set of RNTIs. In this case, each PRACH occasion is mapped to one RNTI. Alternatively, in an embodiment, the association may be a one-to-more mapping between a PRACH occasion in the set of PRACH occasions and two or more RNTIs in the set of RNTIs. In this case, each PRACH occasion is mapped to two or more RNTIs. Based on the PRACH used for the determined preamble, the terminal device may randomly select one RNTI from the corresponding two or more RNTIs. Alternatively, in an embodiment, the association may be a more-to-one mapping between two or more PRACH occasions in the set of PRACH occasions and an RNTI in the set of RNTIs. In this case, two or more PRACH occasions are mapped to one RNTI.

Alternatively, in some embodiments, the RNTI information may indicate at least one RNTI. In an embodiment, the RNTI information may indicate only one RNTI. In this case, for different preambles, the same RNTI is used for the PUSCH. In order to mitigate PUSCH collision between different terminal devices, different PUSCH time-frequency resources and different PRACH occasions may be allocated.

Alternatively, in an embodiment, the RNTI information may indicate a plurality of RNTIs. In this case, the terminal device may randomly determine one RNTI from the plurality of RNTIs. For example, a set of three RNTIs may be indicated in the RNTI information, and the terminal device can select any one of the three RNTIs randomly.

In some embodiments, the RNTI information may be signaled in a signaling message from a network node such as a base station (e.g. a gNB). The signaling message may be a radio resource control (RRC) message. Alternatively, in some embodiments, the RNTI information may be predefined in the terminal device.

After determining the RNTI in block 304, in block 306, the terminal device generates a PUSCH message based on the determined RNTI. Generally, the RNTI is used for PUSCH scrambling sequence initialization. Then in block 308, the terminal device transmits a request message to the network node in the two-step random access procedure. The request message may comprise the preamble determined in block 302 and the PUSCH message generated in block 306. The preamble may be transmitted in the PRACH occasion, and the PUSCH message may be transmitted in the PUSCH time-frequency resource.

Additionally, in some embodiments, in response to transmitting the request message, the terminal device may receive a response message, as shown in block 310. In some embodiments, the response message may comprise a selected RNTI. If the network node fails to decode the PUSCH message while successfully detecting the preamble in the request message, the network node may select an RNTI for a subsequent two-step random access procedure, and transmit a response message comprising the selected RNTI to the terminal device. After receiving the response message, the terminal device may obtain the selected RNTI and use it in the subsequent random access procedure, instead of determining the RNTI according to the RNTI information. Additionally, the selected RNTI may be added to the RNTI information stored in the terminal device. In some embodiments, the response message may be received on a physical downlink shared channel, PDSCH. Alternatively, the response message may be received as control information on a physical downlink control channel, PDCCH.

Please note that the order for performing the steps as shown in FIG. 3 is illustrated just as an example. In some implementations, some steps may be performed in a reverse order or in parallel. In some other implementations, some steps may be omitted or combined.

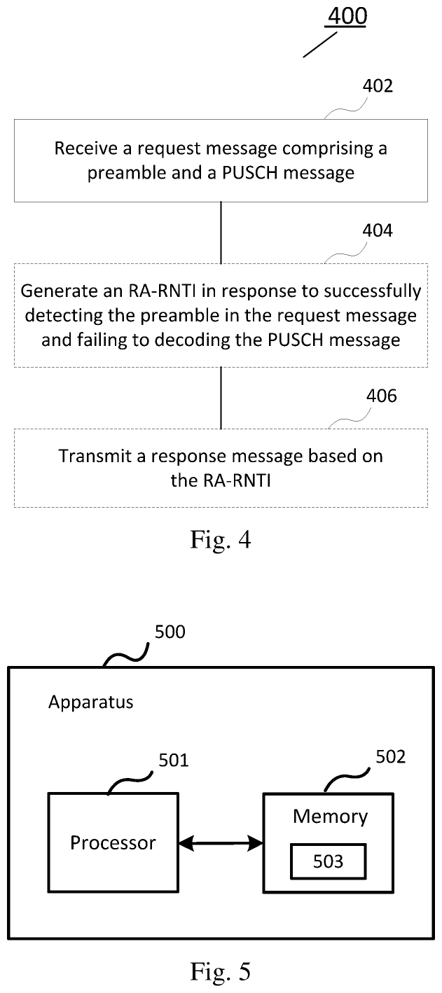

FIG. 4 is a flowchart illustrating a method 400 according to some embodiments of the present disclosure. The method 400 illustrated in FIG. 4 may be performed by an apparatus implemented in a network node or communicatively coupled to a network node. In accordance with an exemplary embodiment, the network node may be a base station, e.g. a gNB. In the following description with respect to FIG. 4, for the same or similar parts as those in the previous exemplary embodiments, the detailed description will be properly omitted.

According to the exemplary method 400 illustrated in FIG. 4, the network node may receive a request message including a preamble and a PUSCH message in a two-step random access procedure, as shown in block 402. In some embodiments, the preamble may be determined according to preamble information, and the PUSCH message may be based on an RNTI determined according to RNTI information. The details of the preamble information and the RNTI information have been described above, and thus are omitted herein.

In some embodiments in which the RNTI information indicates an association between a set of preambles in the preamble information and a set of RNTIs, the network node may detect the preamble in the request message, and determine the RNTI based on the detected preamble according to the RNTI information stored in the network node. Then the network node may decode the PUSCH message based on the determined RNTI.

In some embodiments in which the RNTI information indicates an association between a set of PRACH occasions in the preamble information and a set of RNTIs, the network node may detect the preamble in the request message, and determine the RNTI based on the PRACH occasion used for the detected preamble according to the RNTI information. Then the network node may decode the PUSCH message based on the determined RNTI.

In some embodiments in which the RNTI information indicates one RNTI, the network node may detect the preamble in the request message, and decode the PUSCH message based on the one RNTI. In some embodiments in which the RNTI information indicates a plurality of RNTIs, the network node may detect the preamble in the request message, and blindly decode the PUSCH message based on the plurality of RNTIs.

Further, in some embodiments, if the network node successfully detects the preamble in the request message and fails to decode the PUSCH message, the network node may generate an RA-RNTI based on the detected preamble, as shown in block 404. In some embodiments, the generation of the RA-RNTI may be further based on the PRACH occasion used for the detected preamble. Then in block 406, the network node may transmit a response message based on the RA-RNTI. The RA-RNTI may be used for scrambling the response message. In some embodiments, the response message may comprise a selected RNTI to be used in a subsequent two-step random access procedure. In some embodiments, the response message may be transmitted on a PDCCH or a PDSCH.

It can be therefore seen that, with the proposed solutions for the two-step random access procedure according to the above embodiments, the terminal device can determine the RNTI used for the PUSCH in the request message in the two-step random access procedure.

The various blocks shown in FIGS. 3-4 may be viewed as method steps, and/or as operations that result from operation of computer program code, and/or as a plurality of coupled logic circuit elements constructed to carry out the associated function(s). The schematic flow chart diagrams described above are generally set forth as logical flow chart diagrams. As such, the depicted order and labeled steps are indicative of specific embodiments of the presented methods. Other steps and methods may be conceived that are equivalent in function, logic, or effect to one or more steps, or portions thereof, of the illustrated methods. Additionally, the order in which a particular method occurs may or may not strictly adhere to the order of the corresponding steps shown.

FIG. 5 is a block diagram illustrating an apparatus 500 according to various embodiments of the present disclosure. As shown in FIG. 5, the apparatus 500 may comprise one or more processors such as processor 501 and one or more memories such as memory 502 storing computer program codes 503. The memory 502 may be non-transitory machine/processor/computer readable storage medium. In accordance with some exemplary embodiments, the apparatus 500 may be implemented as an integrated circuit chip or module that can be plugged or installed into a terminal device as described with respect to FIG. 3, or a network node as described with respect to FIG. 4.

In some implementations, the one or more memories 502 and the computer program codes 503 may be configured to, with the one or more processors 501, cause the apparatus 500 at least to perform any operation of the method as described in connection with FIG. 3. In such embodiments, the apparatus 500 may be implemented as at least part of or communicatively coupled to the terminal device as described above. As a particular example, the apparatus 500 may be implemented as a terminal device.

In other implementations, the one or more memories 502 and the computer program codes 503 may be configured to, with the one or more processors 501, cause the apparatus 500 at least to perform any operation of the method as described in connection with FIG. 4. In such embodiments, the apparatus 500 may be implemented as at least part of or communicatively coupled to the network node as described above. As a particular example, the apparatus 500 may be implemented as a network node.

Alternatively or additionally, the one or more memories 502 and the computer program codes 503 may be configured to, with the one or more processors 501, cause the apparatus 500 at least to perform more or less operations to implement the proposed methods according to the exemplary embodiments of the present disclosure.

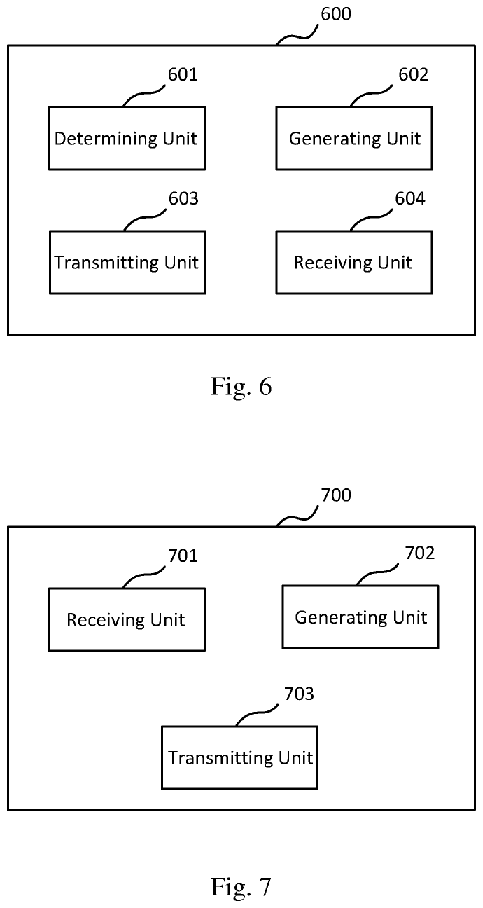

FIG. 6 is a block diagram illustrating an apparatus 600 according to some embodiments of the present disclosure. As shown in FIG. 6, the apparatus 600 may comprise a determining unit 601, a generating unit 602, and a transmitting unit 603. In an exemplary embodiment, the apparatus 600 may be implemented in a terminal device such as UE. The determining unit 601 may be operable to carry out the operation in blocks 302 and 304. The generating unit 602 may be operable to carry out the operation in block 306, and the transmitting unit 603 may be operable to carry out the operation in block 308. Further, the apparatus 600 may also comprise a receiving unit 604 operable to carry out the operation in block 310. Optionally, the determining unit 601, the generating unit 602, the transmitting unit 603 and/or the receiving unit 604 may be operable to carry out more or less operations to implement the proposed methods according to the exemplary embodiments of the present disclosure.

FIG. 7 is a block diagram illustrating an apparatus 700 according to some embodiments of the present disclosure. As shown in FIG. 7, the apparatus 700 may comprise a receiving unit 701. In an exemplary embodiment, the apparatus 700 may be implemented in a network node such as a base station (e.g. a gNB, or an eNB). The receiving unit 701 may be operable to carry out the operation in block 402. Further, the apparatus 700 may also comprise a generating unit 702 and a transmitting unit 703. The generating unit 702 may be operable to carry out the operation in block 404, and the transmitting unit 706 may be operable to carry out the operation in block 406. Optionally, the receiving unit 701, the generating unit 702 and/or the transmitting unit 703 may be operable to carry out more or less operations to implement the proposed methods according to the exemplary embodiments of the present disclosure.

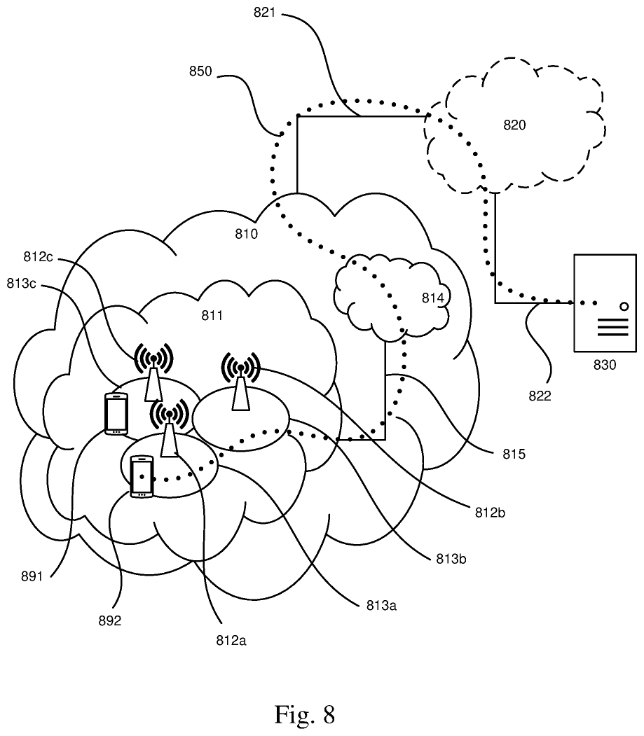

FIG. 8 is a block diagram illustrating a telecommunication network connected via an intermediate network to a host computer in accordance with some embodiments of the present disclosure.

With reference to FIG. 8, in accordance with an embodiment, a communication system includes a telecommunication network 810, such as a 3GPP-type cellular network, which comprises an access network 811, such as a radio access network, and a core network 814. The access network 811 comprises a plurality of base stations 812a, 812b, 812c, such as NBs, eNBs, gNBs or other types of wireless access points, each defining a corresponding coverage area 813a, 813b, 813c. Each base station 812a, 812b, 812c is connectable to the core network 814 over a wired or wireless connection 815. A first UE 891 located in a coverage area 813c is configured to wirelessly connect to, or be paged by, the corresponding base station 812c. A second UE 892 in a coverage area 813a is wirelessly connectable to the corresponding base station 812a. While a plurality of UEs 891, 892 are illustrated in this example, the disclosed embodiments are equally applicable to a situation where a sole UE is in the coverage area or where a sole UE is connecting to the corresponding base station 812.

The telecommunication network 810 is itself connected to a host computer 830, which may be embodied in the hardware and/or software of a standalone server, a cloud-implemented server, a distributed server or as processing resources in a server farm. The host computer 830 may be under the ownership or control of a service provider, or may be operated by the service provider or on behalf of the service provider. Connections 821 and 822 between the telecommunication network 810 and the host computer 830 may extend directly from the core network 814 to the host computer 830 or may go via an optional intermediate network 820. An intermediate network 820 may be one of, or a combination of more than one of, a public, private or hosted network; the intermediate network 820, if any, may be a backbone network or the Internet; in particular, the intermediate network 820 may comprise two or more sub-networks (not shown).

The communication system of FIG. 8 as a whole enables connectivity between the connected UEs 891, 892 and the host computer 830. The connectivity may be described as an over-the-top (OTT) connection 850. The host computer 830 and the connected UEs 891, 892 are configured to communicate data and/or signaling via the OTT connection 850, using the access network 811, the core network 814, any intermediate network 820 and possible further infrastructure (not shown) as intermediaries. The OTT connection 850 may be transparent in the sense that the participating communication devices through which the OTT connection 850 passes are unaware of routing of uplink and downlink communications. For example, the base station 812 may not or need not be informed about the past routing of an incoming downlink communication with data originating from the host computer 830 to be forwarded (e.g., handed over) to a connected UE 891. Similarly, the base station 812 need not be aware of the future routing of an outgoing uplink communication originating from the UE 891 towards the host computer 830.

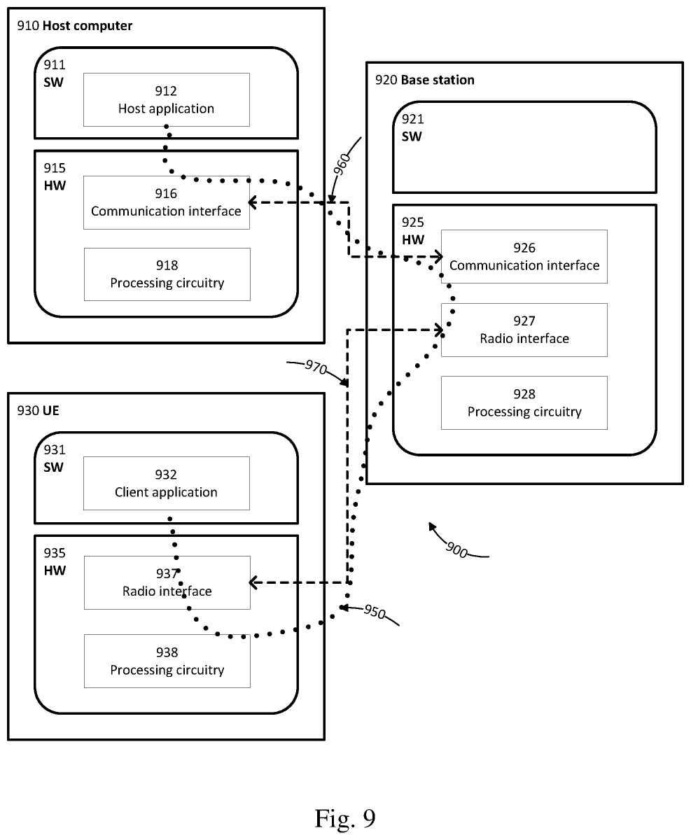

FIG. 9 is a block diagram illustrating a host computer communicating via a base station with a UE over a partially wireless connection in accordance with some embodiments of the present disclosure.

Example implementations, in accordance with an embodiment, of the UE, base station and host computer discussed in the preceding paragraphs will now be described with reference to FIG. 9. In a communication system 900, a host computer 910 comprises hardware 915 including a communication interface 916 configured to set up and maintain a wired or wireless connection with an interface of a different communication device of the communication system 900. The host computer 910 further comprises a processing circuitry 918, which may have storage and/or processing capabilities. In particular, the processing circuitry 918 may comprise one or more programmable processors, application-specific integrated circuits, field programmable gate arrays or combinations of these (not shown) adapted to execute instructions. The host computer 910 further comprises software 911, which is stored in or accessible by the host computer 910 and executable by the processing circuitry 918. The software 911 includes a host application 912. The host application 912 may be operable to provide a service to a remote user, such as UE 930 connecting via an OTT connection 950 terminating at the UE 930 and the host computer 910. In providing the service to the remote user, the host application 912 may provide user data which is transmitted using the OTT connection 950.

The communication system 900 further includes a base station 920 provided in a telecommunication system and comprising hardware 925 enabling it to communicate with the host computer 910 and with the UE 930. The hardware 925 may include a communication interface 926 for setting up and maintaining a wired or wireless connection with an interface of a different communication device of the communication system 900, as well as a radio interface 927 for setting up and maintaining at least a wireless connection 970 with the UE 930 located in a coverage area (not shown in FIG. 9) served by the base station 920. The communication interface 926 may be configured to facilitate a connection 960 to the host computer 910. The connection 960 may be direct or it may pass through a core network (not shown in FIG. 9) of the telecommunication system and/or through one or more intermediate networks outside the telecommunication system. In the embodiment shown, the hardware 925 of the base station 920 further includes a processing circuitry 928, which may comprise one or more programmable processors, application-specific integrated circuits, field programmable gate arrays or combinations of these (not shown) adapted to execute instructions. The base station 920 further has software 921 stored internally or accessible via an external connection.

The communication system 900 further includes the UE 930 already referred to. Its hardware 935 may include a radio interface 937 configured to set up and maintain a wireless connection 970 with a base station serving a coverage area in which the UE 930 is currently located. The hardware 935 of the UE 930 further includes a processing circuitry 938, which may comprise one or more programmable processors, application-specific integrated circuits, field programmable gate arrays or combinations of these (not shown) adapted to execute instructions. The UE 930 further comprises software 931, which is stored in or accessible by the UE 930 and executable by the processing circuitry 938. The software 931 includes a client application 932. The client application 932 may be operable to provide a service to a human or non-human user via the UE 930, with the support of the host computer 910. In the host computer 910, an executing host application 912 may communicate with the executing client application 932 via the OTT connection 950 terminating at the UE 930 and the host computer 910. In providing the service to the user, the client application 932 may receive request data from the host application 912 and provide user data in response to the request data. The OTT connection 950 may transfer both the request data and the user data. The client application 932 may interact with the user to generate the user data that it provides.

It is noted that the host computer 910, the base station 920 and the UE 930 illustrated in FIG. 9 may be similar or identical to the host computer 830, one of base stations 812a, 812b, 812c and one of UEs 891, 892 of FIG. 8, respectively. This is to say, the inner workings of these entities may be as shown in FIG. 9 and independently, the surrounding network topology may be that of FIG. 8.

In FIG. 9, the OTT connection 950 has been drawn abstractly to illustrate the communication between the host computer 910 and the UE 930 via the base station 920, without explicit reference to any intermediary devices and the precise routing of messages via these devices. Network infrastructure may determine the routing, which it may be configured to hide from the UE 930 or from the service provider operating the host computer 910, or both. While the OTT connection 950 is active, the network infrastructure may further take decisions by which it dynamically changes the routing (e.g., on the basis of load balancing consideration or reconfiguration of the network).

Wireless connection 970 between the UE 930 and the base station 920 is in accordance with the teachings of the embodiments described throughout this disclosure. One or more of the various embodiments improve the performance of OTT services provided to the UE 930 using the OTT connection 950, in which the wireless connection 970 forms the last segment. More precisely, the teachings of these embodiments may improve the latency and the power consumption, and thereby provide benefits such as lower complexity, reduced time required to access a cell, better responsiveness, extended battery lifetime, etc.

A measurement procedure may be provided for the purpose of monitoring data rate, latency and other factors on which the one or more embodiments improve. There may further be an optional network functionality for reconfiguring the OTT connection 950 between the host computer 910 and the UE 930, in response to variations in the measurement results. The measurement procedure and/or the network functionality for reconfiguring the OTT connection 950 may be implemented in software 911 and hardware 915 of the host computer 910 or in software 931 and hardware 935 of the UE 930, or both. In embodiments, sensors (not shown) may be deployed in or in association with communication devices through which the OTT connection 950 passes; the sensors may participate in the measurement procedure by supplying values of the monitored quantities exemplified above, or supplying values of other physical quantities from which the software 911, 931 may compute or estimate the monitored quantities. The reconfiguring of the OTT connection 950 may include message format, retransmission settings, preferred routing etc.; the reconfiguring need not affect the base station 920, and it may be unknown or imperceptible to the base station 920. Such procedures and functionalities may be known and practiced in the art. In certain embodiments, measurements may involve proprietary UE signaling facilitating the host computer 910's measurements of throughput, propagation times, latency and the like. The measurements may be implemented in that the software 911 and 931 causes messages to be transmitted, in particular empty or ‘dummy’ messages, using the OTT connection 950 while it monitors propagation times, errors etc.

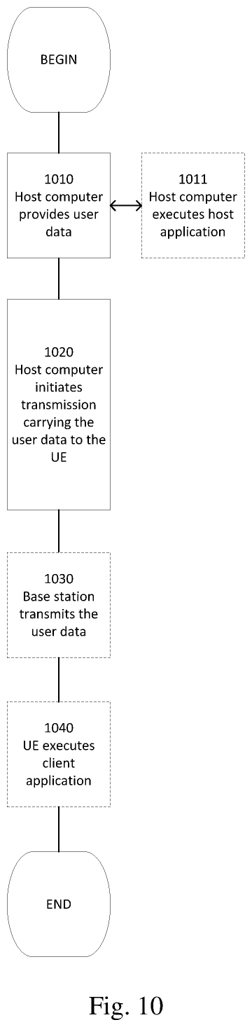

FIG. 10 is a flowchart illustrating a method implemented in a communication system, in accordance with an embodiment. The communication system includes a host computer, a base station and a UE which may be those described with reference to FIG. 8 and FIG. 9. For simplicity of the present disclosure, only drawing references to FIG. 10 will be included in this section. In step 1010, the host computer provides user data. In substep 1011 (which may be optional) of step 1010, the host computer provides the user data by executing a host application. In step 1020, the host computer initiates a transmission carrying the user data to the UE. In step 1030 (which may be optional), the base station transmits to the UE the user data which was carried in the transmission that the host computer initiated, in accordance with the teachings of the embodiments described throughout this disclosure. In step 1040 (which may also be optional), the UE executes a client application associated with the host application executed by the host computer.

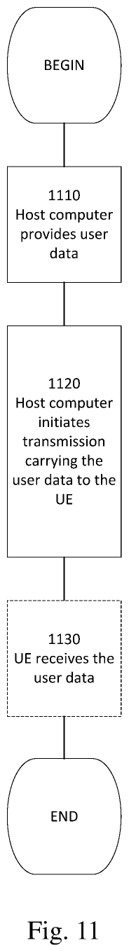

FIG. 11 is a flowchart illustrating a method implemented in a communication system, in accordance with an embodiment. The communication system includes a host computer, a base station and a UE which may be those described with reference to FIG. 8 and FIG. 9. For simplicity of the present disclosure, only drawing references to FIG. 11 will be included in this section. In step 1110 of the method, the host computer provides user data. In an optional substep (not shown) the host computer provides the user data by executing a host application. In step 1120, the host computer initiates a transmission carrying the user data to the UE. The transmission may pass via the base station, in accordance with the teachings of the embodiments described throughout this disclosure. In step 1130 (which may be optional), the UE receives the user data carried in the transmission.

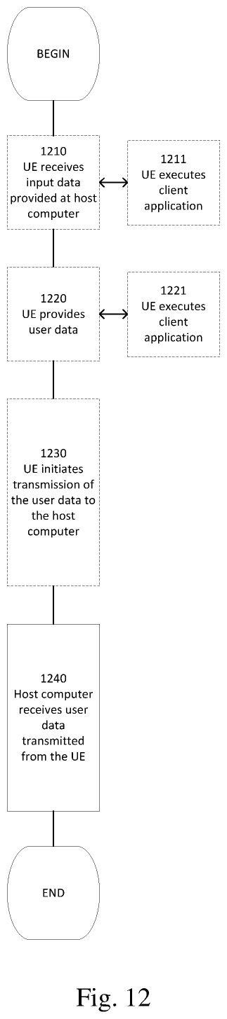

FIG. 12 is a flowchart illustrating a method implemented in a communication system, in accordance with an embodiment. The communication system includes a host computer, a base station and a UE which may be those described with reference to FIG. 8 and FIG. 9. For simplicity of the present disclosure, only drawing references to FIG. 12 will be included in this section. In step 1210 (which may be optional), the UE receives input data provided by the host computer. Additionally or alternatively, in step 1220, the UE provides user data. In substep 1221 (which may be optional) of step 1220, the UE provides the user data by executing a client application. In substep 1211 (which may be optional) of step 1210, the UE executes a client application which provides the user data in reaction to the received input data provided by the host computer. In providing the user data, the executed client application may further consider user input received from the user. Regardless of the specific manner in which the user data was provided, the UE initiates, in substep 1230 (which may be optional), transmission of the user data to the host computer. In step 1240 of the method, the host computer receives the user data transmitted from the UE, in accordance with the teachings of the embodiments described throughout this disclosure.

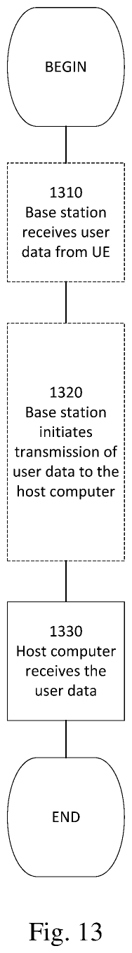

FIG. 13 is a flowchart illustrating a method implemented in a communication system, in accordance with an embodiment. The communication system includes a host computer, a base station and a UE which may be those described with reference to FIG. 8 and FIG. 9. For simplicity of the present disclosure, only drawing references to FIG. 13 will be included in this section. In step 1310 (which may be optional), in accordance with the teachings of the embodiments described throughout this disclosure, the base station receives user data from the UE. In step 1320 (which may be optional), the base station initiates transmission of the received user data to the host computer. In step 1330 (which may be optional), the host computer receives the user data carried in the transmission initiated by the base station.

In general, the various exemplary embodiments may be implemented in hardware or special purpose chips, circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, random access memory (RAM), etc. As will be appreciated by one of skill in the art, the function of the program modules may be combined or distributed as desired in various embodiments. In addition, the function may be embodied in whole or partly in firmware or hardware equivalents such as integrated circuits, field programmable gate arrays (FPGA), and the like.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

1. A method performed by a terminal device comprising:
determining a preamble for a two-step random access procedure;
determining a radio network temporary identity, RNTI, for the two-step random access procedure according to RNTI information;
generating a scrambling sequence for a physical uplink shared channel, PUSCH, message based on the determined RNTI; and
transmitting a request message comprising the preamble and the PUSCH message in the two-step random access procedure.

2. The method according to claim 1, wherein the preamble is determined from a set of preambles, and the RNTI information indicates an association between the set of preambles and a set of RNTIs.

3. The method according to claim 2, wherein the association is any of one-to-one mapping between a preamble in the set of preambles and an RNTI in the set of RNTIs, one-to-more mapping between a preamble in the set of preambles and two or more RNTIs in the set of RNTIs, or more-to-one mapping between two or more preambles in the set of preambles and an RNTI in the set of RNTIs.

4. The method according to claim 2, wherein the RNTI is determined based on the determined preamble.

5. The method according to claim 1, wherein the RNTI information indicates an association between a set of physical random access channel, PRACH, occasions and a set of RNTIs.

6. The method according to claim 5, wherein the association is any of one-to-one mapping between a PRACH occasion in the set of PRACH occasions and an RNTI in the set of RNTIs, one-to-more mapping between a PRACH occasion in the set of PRACH occasions and two or more RNTIs in the set of RNTIs, or more-to-one mapping between two or more PRACH occasions in the set of PRACH occasions and an RNTI in the set of RNTIs.

7. The method according to claim 5, wherein the RNTI is determined based on the PRACH occasion used for the determined preamble.

8. The method according to claim 1, wherein the RNTI information indicates at least one RNTI.

9. The method according to claim 8, wherein the RNTI information indicates a plurality of RNTIs, and
wherein the RNTI is determined randomly from the plurality of RNTIs.

10. The method according to claim 1, wherein a preamble is associated with a PUSCH time-frequency resource.

11. The method according to claim 1, wherein the RNTI information is predefined or signaled in a signaling message.

12. The method according to claim 1, wherein the preamble is determined according to preamble information, and the preamble information is predefined or signaled in a signaling message.

13. The method according to claim 11, wherein the signaling message is a radio resource control, RRC, message.

14. The method according to claim 1, further comprising:
receiving, in response to transmitting the request message, a response message comprising a selected RNTI; and
wherein the selected RNTI is used in a subsequent two-step random access procedure.

15. The method according to claim 14, wherein the response message is received on a physical downlink shared channel, PDSCH, or a physical downlink control channel, PDCCH.

16. A method performed by a network node comprising:
receiving a request message including a preamble and a physical uplink shared channel, PUSCH, message in a two-step random access procedure, a scrambling sequence for the PUSCH message being based on a radio network temporary identity, RNTI, determined according to RNTI information.

17-19. (canceled)

20. The method according to claim 16, wherein the RNTI information indicates an association between a set of physical random access channel, PRACH, occasions and a set of RNTIs.

21. The method according to claim 20, wherein the association is any of one-to-one mapping between a PRACH occasion in the set of PRACH occasions and an RNTI in the set of RNTIs, one-to-more mapping between a PRACH occasion in the set of PRACH occasion and two or more RNTIs in the set of RNTIs, or more-to-one mapping between two or more PRACH occasions in the set of PRACH occasions and an RNTI in the set of RNTIs.

22. The method according to claim 20, wherein receiving the request message comprises:
detecting the preamble in the request message;
determining the RNTI based on a PRACH occasion used for the detected preamble according to the RNTI information; and
decoding the PUSCH message based on the determined RNTI.

23-30. (canceled)

31. A terminal device comprising:
one or more processors; and
one or more memories comprising computer program codes,
the one or more memories and the computer program codes configured to, with the one or more processors, cause the terminal device to:
determine a preamble for a two-step random access procedure;
determine a radio network temporary identity, RNTI, for the two-step random access procedure according to RNTI information;
generate a scrambling sequence for a physical uplink shared channel, PUSCH, message based on the determined RNTI; and
transmit a request message comprising the preamble and the PUSCH message in the two-step random access procedure.

32-36. (canceled)
